(19) United States
(12) Patent Application Publication
(10) Pub. No.: US 2006/0074151 A1
(43) Pub. Date: Apr. 6, 2006

(54) Low expansion dielectric compositions

(75) Inventors: Guoren He, Franklin, NH (US); William D. Varnell, Concord, NH (US); Thomas J. Williams, Concord, NH (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Polyclad Laminates, Inc., Franklin, NH (US)

(21) Appl. No.: 10/952,102

(22) Filed: Sep. 28, 2004

(51) Int. Cl. C08L 63/00

(52) U.S. Cl. 523/457

(57) ABSTRACT

Dielectric compositions comprising a first component and a second component present at about 5 parts to about 60 parts filler per 100 parts of the first component are disclosed. In certain examples, the first component includes a polyphenylene ether, a polyepoxide, and optionally a compatibilizing agent and a catalyst. Certain examples of the dielectric compositions disclosed herein have low coefficients of thermal expansion. Prepregs, laminates, molded articles and printed circuit boards using the dielectric compositions are also disclosed.

### FIELD OF THE INVENTION

Certain examples disclosed herein relate generally to dielectric compositions. More particularly, certain examples relate to dielectric compositions that have low coefficients of thermal expansion.

### BACKGROUND

Curable polyphenylene ether and polyphenylene oxide compounds have been used in printed circuit boards (PCBs). Glass fiber cloth laminates made from these compositions have low dielectric constants and dissipation factors. Products using these compositions also have higher toughness than typical epoxy glass laminates which have been used in PCBs. Laminates made from the compositions have relatively higher thermal expansion coefficients in the Z-direction as compared to typical epoxy resin systems. High thermal expansion in the Z-direction can cause a risk of failure in multilayer printed circuit boards when they undergo thermal shock in manufacturing or re-work process, or even in use.

### SUMMARY

Certain examples are directed to dielectric compositions that provide low thermal expansion. In certain examples, the dielectric compositions impart low thermal expansion to prepregs, laminates, molded articles and printed circuit boards using the compositions. For example, the coefficient of thermal expansion of prepregs, laminates, molded articles and printed circuit boards using the dielectric compositions disclosed here can be reduced by about 5% to about 30% or more.

In accordance with a first aspect, a dielectric composition comprising a first component and a second component is provided. In certain examples, the first component of the dielectric composition comprises a polyphenylene ether, a polyepoxide, and a compatibilizing agent. In certain examples, the first component also includes a catalyst. In some examples, the polyphenylene ether is present from about 20% to about 55% by weight based on the weight of the first component. In other examples, the polyepoxide is present from about 20% to about 60% by weight based on the weight of the first component. In yet other examples, the polyepoxide comprises about 10% to about 30% bromine as aryl substituents. In certain examples, the polyepoxide comprises a bisphenol polyglicydyl ether having an average of about one aliphatic hydroxy group per molecule. In some examples, the first component may further comprise an inert solvent, dispersing agents and additional materials, such as those described below. In certain examples, the second component of the dielectric composition comprises about 5 parts to about 60 parts of filler per 100 parts of the first component. In some examples, the filler is talc, clay, mica, silica, alumina, calcium carbonate or mixtures thereof.

In accordance with an additional aspect, a dielectric composition comprising a first component and about 5 parts to about 60 parts of a second component per 100 parts of the first component is disclosed. In certain examples, the first component comprises a compound having two or more structural units having formula (I) shown below.

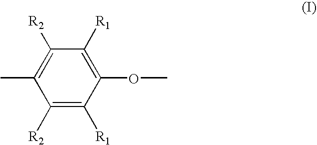

In certain examples, each R₁ and R₂ of formula (I) is independently selected from the group consisting of hydrogen, primary or secondary lower alkyl, primary or secondary lower alkenyl, primary or secondary lower alkynyl, phenyl, aminoalkyl, diaminoalkyl, acyl, hydrocarbonoxy, and halohydrocarbonoxy. In certain other examples, each R₁ is independently selected from the group consisting of halogen, primary or secondary lower alkyl, phenyl, haloalkyl, aminoalkyl, hydroxycarbonoxy, or halohydrocarbonoxy wherein at least two carbon atoms separate the halogen and oxygen atoms, and each R₂ is independently selected from the group consisting of hydrogen, halogen, primary or secondary lower alkyl, phenyl, haloalkyl, hydrocarbonoxy or halohydroxycarbonoxy as defined for R₁. In some examples, the compound having two or more structural units having formula (I) is present from about 20% to about 50% by weight based on the weight of the first component.

In accordance with certain examples, the first component may further comprise a compound having formula (II) shown below.

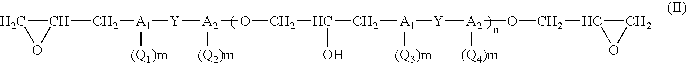

In certain examples, each of Q₁, Q₂, Q₃ and Q₄ is independently selected from the group consisting of hydrogen, methyl, aryl, primary or secondary lower alkyl, and halogens, such as bromine. In certain examples, m is 0-4, n has an average value up to 1, each of A₁ and A₂ is a monocyclic divalent aromatic radical and Y is a bridging radical in which one or two atoms separate A₁ from A₂. In some examples, the compound having formula (II) is present from about 20% to about 60% by weight based on the weight of the first component.

In accordance with certain examples, the dielectric composition may further comprise one or more compatibilizing agents to compatabilize (a) one or more compounds having two or more structural units as shown in formula (I) and (b) one or more compounds having formula (II). The exact nature and amount of the compatibilizing agent may depend on the selected compounds having formulae (I) and (II), and in certain examples the compatibilizing agent is selected from one or more transition metal salts.

In accordance with certain examples, the dielectric composition may further comprise one or more catalysts present in a catalytically effective amount. The particular catalyst or catalysts selected may depend on the one or more selected compounds having formulae (I) and (II), and in certain examples the catalyst is selected from one or more of imidazole based compounds and/or arylene polyamine based compounds.

In accordance with another aspect, a dielectric composition comprising a first component and about 5 parts to about 60 parts of a second component per 100 parts of the first component and providing a pre-glass transition temperature coefficient of thermal expansion of no greater than about 50 ppm/° C., more particularly about 45 ppm/° C., e.g., no greater than about 40 ppm/° C., is provided. In certain examples, the first component comprises one or more polyphenylene ether compounds and one or more polyepoxide compounds, such as those disclosed herein, for example. In certain examples, a compatibilizing agent and/or a catalyst are optionally included in the first component of the dielectric composition. In certain examples, the second component comprises one or more fillers. In some examples, about 15-30 parts filler per 100 parts first component is used.

In accordance with another aspect, a dielectric composition comprising a first component and about 5 parts to about 60 parts of a second component per 100 parts of the first component and providing a post-glass transition temperature coefficient of thermal expansion of no greater than about 300 ppm/° C., more particularly about 250 ppm/° C., e.g., no greater than about 250 ppm/° C. is provided. In certain examples, the first component comprises one or more polyphenylene ether compounds and one or more polyepoxide compounds, such as those disclosed herein, for example. In certain examples, a compatibilizing agent and/or a catalyst are optionally included in the first component of the dielectric composition. In certain examples, the second component comprises one or more fillers. In some examples, about 15-30 parts filler per 100 parts first component is used.

In accordance with yet an additional aspect, a dielectric composition comprising a first component and about 5 parts to about 60 parts of a second component per 100 parts of the first component and having a glass transition temperature of at least about 140° C., more particularly about 160 to 180° C., e.g., about 175° C., is provided. In certain examples, the first component comprises a polyphenylene ether and a polyepoxide. In certain examples, a compatibilizing agent and/or a catalyst are optionally included in the first component of the dielectric composition. In certain examples, the second component comprises one or more fillers. In some examples, about 15-30 parts filler per 100 parts first component is used.

In accordance with yet an additional aspect, a dielectric composition comprising a first component and about 5 parts to about 60 parts of a second component per 100 parts of the first component and providing a peel strength of at least about 4 pounds per inch width, more particularly about 4 to 6 pound, e.g., about 5 pound per inch width as tested by IPC-TM-650 2.4.8C (dated December 1994 and entitled “Peel Strength of Metallic Clad Laminates”) and 2.4.8.2 is provided. In certain examples, the first component comprises a polyphenylene ether and a polyepoxide. In certain examples, a compatibilizing agent and/or a catalyst are optionally included in the first component of the dielectric composition. In certain examples, the second component comprises one or more fillers. In some examples, about 15-30 parts filler per 100 parts first component is used.

In accordance with another aspect, a dielectric composition comprising a first component and about 5 parts to about 60 parts of a second component per 100 parts of the first component and having a dielectric constant at 1 MHz (50% resin content) of no greater than 5.0, more particularly about 4 to 4.5, e.g., about 4.0 or less, as tested by the two fluid cell method (IPC-TM-650 2.5.5.3C dated December 1987 and entitled “Permittivity (Dielectric Constant) and Loss Tangent (Dissipation Factor) of Materials (Two Fluid Cell Method)”) is disclosed. In certain examples, the first component comprises a polyphenylene ether and a polyepoxide. In certain examples, a compatibilizing agent and/or a catalyst are optionally included in the first component of the dielectric composition. In certain examples, the second component comprises one or more fillers. In some examples, about 15-30 parts filler per 100 parts first component is used.

In accordance with yet another aspect, a dielectric composition comprising a first component and about 5 parts to about 60 parts of a second component per 100 parts of the first component and having a dielectric dissipation factor at 1 MHz (50% resin content) of about 0.02, more particularly about 0.008 to 0.015° C., e.g., about 0.009 or less, as tested by the two fluid cell method (IPC-TM-650 2.5.5.3C dated December 1987 and entitled “Permittivity (Dielectric Constant) and Loss Tangent (Dissipation Factor) of Materials (Two Fluid Cell Method)”) is provided. In certain examples, the first component comprises a polyphenylene ether and a polyepoxide. In certain examples, a compatibilizing agent and/or a catalyst are optionally included in the first component of the dielectric composition. In certain examples, the second component comprises one or more fillers. In some examples, about 15-30 parts filler per 100 parts first component is used.

In accordance with an additional aspect, a prepreg is disclosed. In certain examples, the prepreg comprises one or more of the compositions disclosed herein disposed on or in a substrate. Exemplary devices, such as laminates and printed circuit boards, that use one or more prepregs are discussed in more detail below.

In accordance with another aspect, a laminate is provided. In certain examples, the laminate comprises at least two layers wherein, prior to curing, one layer is a prepreg. In some examples, the laminate comprises two or more prepregs wherein each prepreg of the laminate is impregnated with the same composition, whereas in other examples, the prepregs of the laminate are impregnated with different compositions. In certain examples, the laminate is formed by laminate pressing.

In accordance with yet an additional aspect, a molded article comprising a plurality of layers impregnated with one or more of the dielectric compositions disclosed herein is provided. In certain examples, the layers of the molded article are each impregnated with the same composition, whereas in other examples, the layers of the molded article are impregnated with different compositions.

In accordance with another aspect, a printed circuit board comprising a dielectric substrate having an electrically conductive layer on one or both surfaces is disclosed. In certain examples, the electrically conductive layer may be formed to have a predetermined pattern. In examples employing multiple electrically conductive layers, the layers may be connected electrically with each other. In some examples, the dielectric substrate comprises a glass cloth or a glass non-woven fabric impregnated with one or more of the compositions disclosed herein.

In accordance with a method aspect, a method of reducing the coefficient of thermal expansion in a prepreg, laminate, molded article or printed circuit board is provided. The method includes disposing on a substrate one or more compositions comprising a first component and about 5 parts to about 60 parts of a second component per 100 parts of the first component. In certain examples, the first component comprises a polyphenylene ether, a polyepoxide, an effective amount of a compatibilizing agent, and optionally a catalyst. In certain examples, the second component is present in an effective amount to reduce the coefficient of thermal expansion of the prepreg, laminate, molded article or printed circuit board. In certain examples, the coefficient of thermal expansion is reduced by about 5% to about 30% using one or more of the compositions disclosed herein.

In accordance with another aspect, a method of facilitating prepreg or printed circuit board assembly is provided. In certain examples, the method comprises providing one or more of the dielectric compositions disclosed herein.

The compositions, prepregs, laminates, molded articles, and printed circuit boards disclosed herein provide substantial commercial advantages. Reductions in thermal expansion that may be achieved using at least certain examples of the compositions disclosed herein allow for assembly and manufacture of prepregs, laminates, molded articles, printed circuit boards, etc. that are at a reduced risk for failure due to thermal expansion, among other advantages.

### BRIEF DESCRIPTION OF THE DRAWINGS

Certain examples are described below with reference to the accompanying drawings in which:

FIG. 1 is a schematic of a prepreg, in accordance with certain examples;

FIG. 2 is a schematic of a laminate, in accordance with certain examples;

FIG. 3 is a schematic of a molded article, in accordance with certain examples;

FIG. 4 is an schematic of a printed circuit board, in accordance with certain examples;

FIG. 5 is a table of data showing measured and normalized values for exemplary compositions comprising different fillers, in accordance with certain examples; and

FIGS. 6-15 are graphs showing comparisons of the different fillers used in the exemplary compositions listed in FIG. 5, in accordance with certain examples.

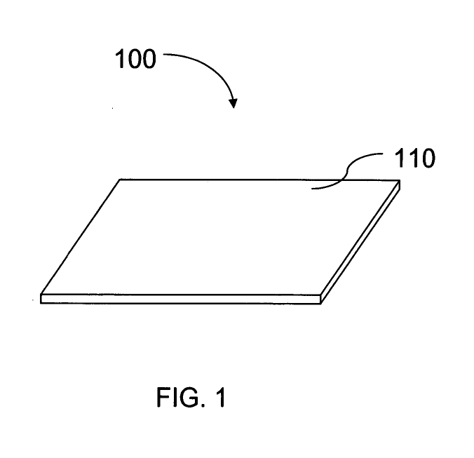

The person or ordinary skill in the art, given the benefit of this disclosure, will recognize that the features of FIGS. 1-4 are not necessarily to scale and certain features in the figures may be enlarged or distorted relative to other features to provide a more user-friendly description of the inventive aspects and examples described herein.

### DETAILED DESCRIPTION OF CERTAIN EXAMPLES

It will be recognized by the person of ordinary skill in the art, given the benefit of this disclosure, that examples of the compositions disclosed herein, and exemplary devices using exemplary compositions, provide at least some advantages not achieved with existing compositions. The compositions can be used in assembly of various single and multi-layered structures including, but not limited to, laminates, printed circuit boards, etc., to provide devices with low coefficients of thermal expansion.

As used herein, the term “low coefficient of thermal expansion” refers to materials having a pre-glass transition temperature coefficient of thermal expansion no greater than about 50 ppm/° C., more particularly about 45 ppm/° C., e.g., no greater than about 40 ppm/° C. In certain other examples, “low coefficient of thermal expansion” refers to materials having a post-glass transition temperature coefficient of thermal expansion no greater than about 270 ppm/° C., more particularly about 250 to 260 ppm/° C., e.g., no greater than about 260 ppm/° C. The person of ordinary skill in the art, given the benefit of this disclosure, will recognize that thermal expansion coefficients are dependent, at least in part, on the exact chemical make-up of the composition. In certain examples, by adding filler to a composition, the pre-glass transition temperature coefficient of thermal expansion can be reduced from about 55-60 ppm/° C. (unfilled) to about 35-49 ppm/° C. (filled) depending, for example, on the filler nature and content. In certain examples involving printed circuit boards (PCBs) including the compositions provided herein, compositions having low thermal coefficients of thermal expansion provide more reliable PCBs, with lower fail rates during PCB assembly as the active components are soldered to the PCB, and during use, as the PCB is powered on and off. Without wishing to be bound by any particular scientific theory, examples of the compositions provided herein can reduce PCB failure rates by reducing the cracking of electrical interconnects in the Z-direction as heat is generated or applied during PCB assembly and use.

In accordance with certain examples, the compositions disclosed herein include one or more polyphenylene ether compounds. In certain examples, polyphenylene ether compounds include two or more structural units having a formula as shown in formula (I) below.

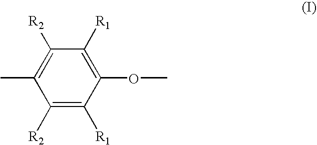

In certain examples, each R₁ and R₂ is independently selected from the group consisting of hydrogen, primary or secondary lower alkyl (e.g., alkyl containing between about 1-7 carbon atoms), primary or secondary lower alkenyl (e.g., alkenes containing between about 2-7 carbon atoms), primary or secondary lower alkynyl (e.g., alkynes containing between about 2-7 carbon atoms), phenyl, aminoalkyl, diaminoalkyl, acyl, hydrocarbonoxy, and halohydrocarbonoxy. In certain other examples, each R₁ is independently selected from the group consisting of halogen, primary or secondary lower alkyl, phenyl, haloalkyl, aminoalkyl, hydroxycarbonoxy, or halohydrocarbonoxy wherein at least two carbon atoms separate the halogen and oxygen atoms; and each R₂ is independently hydrogen, halogen, primary or secondary lower alkyl, phenyl, haloalkyl, hydrocarbonoxy or halohydroxycarbonoxy as defined for R₁. Examples of suitable primary lower alkyl groups are methyl, ethyl, n-propyl, n-butyl, isobutyl, n-amyl, isoamyl, 2-methylbutyl, n-hexyl, 2,3-dimethylbutyl, 2-, 3-, or 4-methylpentyl and the corresponding heptyl groups. Examples of secondary lower alkyl groups are isopropyl, sec-butyl, and 3-pentyl. More particularly, any alkyl radicals are straight chain rather than branched. In certain examples, each R₁ is alkyl or phenyl, especially C1-4 alkyl, and each R₂ is hydrogen.

In accordance with certain examples, both homopolymer and copolymer polyphenylene ethers can be used in the first component of the compositions disclosed herein. Suitable homopolymers are those containing, for example, 2,6-dimethyl-1,4-phenylene ether units. Suitable copolymers include, for example, random copolymers containing such units in combination with (for example) 2,3,6-trimethyl-1,4-phenylene ether units. Many suitable random copolymers, as well as homopolymers, will be readily selected by the person of ordinary skill in the art, given the benefit of this disclosure. Polyphenylene ethers containing moieties which modify properties such as molecular weight, melt viscosity, and/or impact strength may also be used. Such polymers are described in the patent literature and may be prepared by grafting onto the polyphenylene ether in known manner such non-hydroxy-containing vinyl monomers as acrylonitrile and vinylaromatic compounds (e.g., styrene), or such non-hydroxy-containing polymers as polystyrenes and elastomers. In certain examples, the polyphenylene ether may include both grafted and ungrafted moieties. Other suitable polymers are the coupled polyphenylene ethers in which the coupling agent is reacted in a known manner with the hydroxy groups of two polyphenylene ether chains to produce a higher molecular weight polymer containing the reaction product of the hydroxy groups and the coupling agent. Illustrative coupling agents are low molecular weight polycarbonates, quinones, heterocycles, and formals.

In accordance with certain examples, polyphenylene ether compounds having a number average molecular weight within the range of about 3,000-40,000, more particularly at least about 12,000, e.g., at least about 15,000, or a weight average molecular weight within the range of about 20,000-80,000 as determined by gel permeation chromatography may be used in the compositions disclosed herein. The intrinsic viscosity of the polyphenylene ether typically is in the range of about 0.35-0.6 dl/gram, more particularly abut 0.375-0.5 dl/gram, e.g., about 0.4 dl/gram, as measured in chloroform at 25° C.

In accordance with certain examples, polyphenylene ethers may be prepared by the known oxidative coupling of a corresponding monohydroxyaromatic compound. Particularly useful and readily available monohydroxyaromatic compounds are 2,6-xylenol (wherein R₁ and one R₂ of formula (I) are methyl and the other R₂ is hydrogen), whereupon the polymer may be characterized as a poly (2,6-dimethyl-1,4-phenylene ether), and 2,3,6-trimethylphenol (wherein each R₁ and one R₂ of formula (I) are methyl and the other R₂ is hydrogen).

In accordance with certain examples, polyphenylene ethers that comprise molecules having aminoalkyl-substituted end groups, as described in numerous patents and publications can also be used in the compositions disclosed herein. Such molecules frequently constitute a substantial proportion of the polyphenylene ether, typically as much as about 90% by weight. Polymers of this type may be obtained by incorporating an appropriate primary or secondary monoamine as one of the constituents of the oxidative coupling reaction mixture.

In accordance with certain examples, the polyphenylene ether component, optionally, can be equilibrated by pre-reaction with an initiator, such as, for example, benzoyl peroxide, 2,2′-azo-bis-isobutyrylnitrile, lauroyl peroxide, tert-butyl peroxy-2-ethylhexanoate and tert-amyl peroxy-2-ethylhexanoate, in the presence of a bisphenol, e.g., bisphenol A (or the like), thereby reducing the molecular size of the polyphenylene ether chains via a cleavage reaction. The use of equilibrated polyphenylene ether may result in a marked reduction in varnish mix viscosity, thus producing better fabric saturation and higher flow prepreg in the treating operation.

In accordance with certain examples, the compositions disclosed herein also include an epoxide compound. In certain examples, the epoxide compound is a polyepoxide compound comprising a bisphenol polyglycidyl ether. In other examples, the epoxide comprises a mixture of such ethers with part of the components of the mixture being halogen-free and the balance thereof containing bromine as aryl substituents. In certain examples, the total amount of bromine therein can range from about 10%-30% by weight.

In accordance with certain examples, polyepoxide compounds can be prepared conventionally, for example, by the reaction of bisphenols with epichlorohydrin. (By “bisphenol” as used herein is meant a compound containing two hydroxyphenyl groups attached to an aliphatic or cycloaliphatic moiety, which may also contain aromatic substituents.) Polyepoxide compounds may generally be represented by the formula: 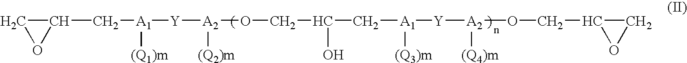
wherein each Q₁, Q₂, Q₃ and Q₄ is independently selected from the group consisting of hydrogen, methyl, aryl, primary or secondary lower alkyl, and halogens, such as bromine. In certain examples, m of formula (II) is 0-4, n has an average value up to 1, each of A₁ and A₂ is a monocyclic divalent aromatic radical and Y is a bridging radical in which one or two atoms separate A₁ from A₂. The O—A₁ and A₂—O bonds in formula II are usually the meta- or para-positions of A₁ and A₂ in relation to Y. In formula II, the A₁ and A₂ values may be unsubstituted phenylene or substituted derivatives thereof, illustrative substituents (one or more) being alkyl, nitro, alkoxy and the like. In certain examples, unsubstituted phenylene radicals are used. Each of A₁ and A₂ may, for example, be ortho- or meta-phenylene and the other para-phenylene, or both may be para-phenylene.

In accordance with certain examples, the bridging radical, Y, may be one in which one or two atoms, preferably one, separate A₁ and A₂. In certain examples, Y may be a hydrocarbon radical and particularly a saturated radical such as methylene, cyclohexylmethylene, ethylene, isopropylidene, neopentylidene, cyclohexylidene or cyclopentadecylidene, especially a gem-alkylene (alkylidene) radical and more particularly isopropylidene. Also included, however are radicals that contain atoms other than carbon and hydrogen; for example, carbonyl, oxy, thio, sulfoxy, and sulfone.

In accordance with certain examples, the epoxide component of the compositions may comprise at least two bisphenol polyglycidyl ethers, one being brominated (m of formula (II) is 1-4, more particularly 2) and the other bromine-free (m is 0).

The proportions thereof are based on a bromine content for the epoxide component of about 10%-30%. Exemplary materials are commercially available from Shell Chemical Co., and similar products prepared from epichlorohydrin and tetrabromobisphenol A. Without wishing to be bound by any particular scientific theory, a purpose of the brominated compounds is to provide flame retardancy. In other examples, halogen flame retardants may be omitted and phosphorous flame retardants, such as those described in commonly assigned U.S. patent application Ser. No. ______ (Attorney Docket No. P2001-700019) entitled “Flame Retardant Compositions,” the entire disclosure of which is incorporated herein by reference for all purposes, may be used instead.

In accordance with certain examples, a polyepoxide that is halogen-free may be used. For example, halogen-free polyepoxide can be used, and a halogen, such as bromine, can be added to provide a halogenated composition. In certain examples, the halogen may be provided by one or more halogenated organic compounds, which may or may not be completely soluble in any organic solvents used to prepare the composition. Exemplary halogenated compounds include, but are not limited to, highly brominated aryl compounds, e.g., decabromodiphenyl oxide, tetradecabromodiphenyoxybenzene, decabromodiphenyl ethane, ethylenebistetrabromophthalimide, and tris(tribromophenyl) triazine etc. Exemplary commercially available halogenated compounds include, for example, Saytex BT-93, Saytex 8010, Saytex 102E, Saytex 120, etc. (available from Albemarle Corporation, Baton Rouge, La.). Additional suitable halogenated compounds will be readily selected by the person of ordinary skill in the art, given the benefit of this disclosure.

In accordance with certain examples, the epoxide compound of the first component may include a compound having formula (III) shown below. 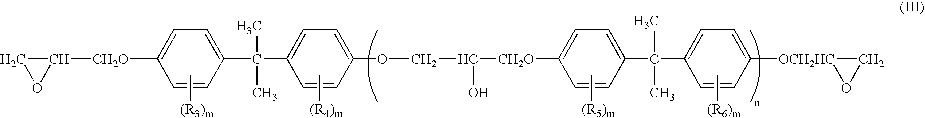
In certain examples of formula (III), R₃, R₄, R₅, and R₆ each is independently selected from the group consisting of halogen, hydrogen, methyl, ethyl, ethylene, propyl, and propylene, in which n has an average value between 0 and 4, and in which m is between 1 and 4.

In accordance with certain examples, the compositions disclosed herein may also include one or more compatibilizing agents present in an effective amount to compatabilize the polyphenylene ether and epoxide components. Without wishing to be bound by any particular scientific theory, compatibilizing agents may be used to improve the solubility or miscibility of compounds or chemicals that are not typically soluble with each other. In certain examples, the compatibilizing agent is an intermediate that typically is soluble with both reagents and helps keep the total solution homogeneous. The exact nature of the compatibilizing agent can vary depending on the selected polyphenylene ether and selected polyepoxide. In certain examples, the compatibilizing agent is a non-metal agent, e.g., surfactant, dispersing agent, etc. In some examples, the compatibilizing agent is a poly(styrene maleic anhydride), such as SMA EF-40, SMA EF-60, etc. (Sartomer Company, Inc., Exton, Pa.). In yet other examples, the compatibilizing agent is a polyol.

In accordance with certain examples, the compatibilizing agent may be a transition metal salt, such as a zinc salt or a tin salt, e.g., the tin salts disclosed in U.S. Pat. No. 5,262,491, the entire disclosure of which is incorporated herein by reference for all purposes. For example, transition metal salts, such as tin salts, can exhibit phase compatibilization in the compositions disclosed herein as evidenced by behavior characterized by a single glass transition temperature. Additionally, when used with appropriate curing agents and cure accelerators, enhanced cure characteristics of the compositions are realized. The effective amount of the transition metal salt can range from about 0.05% to about 6.0%, e.g., about 1%-5%, by weight of the polyphenylene ether and epoxide components. In certain examples, about 4.8% compatibilizing agent by weight of the polyphenylene ether and epoxide components is used. Exemplary tin metal salts include, for example, stannous octoate, di-alkyl tin dicarboxylates such as dibutyl tin dicarboxylates (e.g. dibutyl tin dioctoate), tin mercaptides (e.g. dibutyl tin dilauryl mercaptide), stannous acetate, stannic oxide, stannous citrate, stannous oxylate, stannous chloride, stannic chloride, tetra-phenyl tin, tetra-butyl tin, tri-n-butyl tin acetate, di-n-butyl tin dilaurate, dimethyl tin dichloride, and the like and even mixtures thereof. Exemplary zinc metal salts include, for example, zinc octoate, di-alkyl zinc dicarboxylates such as dibutyl zinc dicarboxylates (e.g. dibutyl zinc dioctoate), zinc mercaptides, zinc acetate, zinc oxide, zinc citrate, zinc oxylate, zinc chloride, and the like and even mixtures thereof. In at least certain examples, the use of a compatibilizing agent, e.g., a tin metal salt, obviates the need for inclusion of epoxidized novolacs and upstaged epoxy resins as proposed in U.S. Pat. No. 5,043,367, the entire disclosure of which is incorporated herein by reference for all purposes.

In accordance with certain examples, the compositions disclosed herein may also include one or more curing agents and/or catalysts, e.g., imidazoles and arylene polyamines. In certain examples, one or more imidazoles such as, for example, imidazole, 1-methylimidazole, 1,2-dimethylimidazole, 2-methylimidazole, 2-heptadecylimidazole, 2-ethyl-4-methylimidazole, 2-undecylimidazole, and 1-(2-cyanoethyl)-2-phenylimidazole are used as curing agents. In other examples, one or more arylene polyamines, such as, for example, diethyltoluenediamine, tris(dimethylaminomethyl)phenol, and 3-phenyl-1,1-dimethyl urea are used as curing agents. In other examples, imidazole-arylene polyamine mixtures can be used. For example, mixtures containing arylene polyamines with a high degree of alkyl substitution on the aromatic ring, typically at least three such substituents can be used. In some examples, diethylmethyl-substituted meta- and para-phenylenediamines are used as polyamines.

In accordance with certain examples, silane coupling agents can be used as catalysts and/or curing agents. For examples, silanes such as 3-(2-aminoethyl)-aminopropyl trimethoxysilane, gamma-aminopropyl triethoxysilane, and glycidoxypropyl trimethoxysilane can be used. In certain examples, silanes containing one or more amine groups are used. Silanes can be used as co-catalysts or can be the primary catalyst.

In accordance with certain examples, the amount of curing agent can vary depending on the exact polyphenylene ether and epoxide used. In certain examples, the curing agent is present in a catalytically effective amount to achieve curing, particularly rapidly curing after solvent removal. More particularly, the amount of curing agent is at least 4.5 and preferably at least 10 milliequivalents of basic nitrogen per 100 parts of total curable composition, including any basic nitrogen present in the polyphenylene ether (mostly as aminoalkyl-substituted end groups). In examples where a polyphenylene ether essentially free from basic nitrogen is employed, the proportion of curing agent should be increased. (For the purpose of this disclosure, the equivalent weight of an imidazole is its molecular weight and that of a diamine is half its molecular weight.)

In accordance with certain examples, co-catalysts and activators can also be used for achieving advantageous cure rates of the inventive curable composition. Salts of diketones in which one carbon atom separates the carbonyl groups, especially acetylacetonates, and salts of fatty acids, especially stearates and octoates, are examples of suitable forms of zinc, magnesium, or aluminum. Specific examples include zinc acetylacetonate, zinc stearate, magnesium stearate, aluminum acetylacetonate, zinc octoate, zinc neodecanoate, and zinc naphthenate. Additional secondary catalysts include, for example, maleic anhydride and BF₃-ethylamine complex.

In accordance with certain examples, acetylacetonates such as zinc acetylacetonate can form hydrates which readily lose acetylacetone and become insoluble in the organic systems used for prepreg, laminate, molded article and/or printed circuit board preparation. To avoid insolubility, it may be necessary to take steps to maintain the zinc or aluminum in stable dispersion. An exemplary method for maintaining solubility is to subject the composition to continuous agitation. An additional exemplary method is to form an alcoholate of the acetylacetonate, as by reaction with methanol. The alcoholate loses alcohol rather than acetylacetonate under similar conditions, remaining in solution or homogeneous suspension. Another exemplary method for maximizing homogeneity is to employ a fatty acid salt. Still another exemplary method is to employ a titanium compound as a compatibilizer, as disclosed hereinafter.

In accordance with certain examples, co-catalysts can be employed in a cocatalytically effective amount, and generally also serve to improve solvent resistance and flame retardancy. For example, about 0.1% to about 1.5% of zinc, magnesium, or aluminum, based on total curable composition, may be present.

In accordance with certain examples, additional materials may also be present in the first component of the compositions disclosed herein. For example, the bromine content of the curable composition may be supplied in part by materials such as alkyl tetrabromophthalates and/or epichlorohydrin reaction products with mixtures of bisphenol A and tetrabromobisphenol A. The alkyl tetrabromophthalates also serve as plasticizers and flow improvers. Fabric wettability enhancers (e.g., wetting agents and coupling agents) and polar liquids such as n-butyl alcohol, methyl ethyl ketone, polysiloxanes, and tetrahydrofuran, may be advantageous under certain conditions. Such materials as antioxidants, thermal and ultraviolet stabilizers, lubricants, antistatic agents, dyes, and pigments may also be present.

In accordance with certain examples, the second component of the compositions disclosed herein comprises one or more fillers in an effective amount to provide low coefficients of thermal expansion. The exact nature of the filler can vary depending on the selected polyphenylene ether and polyepoxide compounds, and in certain examples, the filler is selected from one or more of talc, silica (e.g., fused silica such as Fuselex E2, crystalline silica such as Minusil 5), hydrogels, organogels, aerogels, lyogels, clay, mica, alumina, spodumene, calcium carbonate, mixtures thereof and other suitable fillers that can reduce the coefficient of thermal expansion and that will be selected by the person of ordinary skill in the art, given the benefit of this disclosure. In certain examples, the mean particle size of the fillers can vary from about 1 micron to about 10 microns. In certain examples, the fillers can have specific gravities ranging from about 1.2 to about 3.5. In certain examples, the filler may be ground, pulverized, filtered or sintered prior to use. In other examples, one or more dyes, colorants, thickeners, stabilizers, additives, etc. may be added to the filler prior to addition to the first component. In accordance with certain examples, the filler can be mixed with the first component using standard techniques such as, for example, stirring, blending, mixing, shaking, vortexing, agitating and the like. It will be within the ability of the person of ordinary skill in the art, given the benefit of this disclosure, to select suitable fillers and suitable methods for mixing the fillers with the first component of the compositions disclosed herein.

In accordance with certain examples, the filler may be present in an effective amount to reduce the pre- or post glass transition temperature of coefficient of thermal expansion by at least about 5%, more particularly at least about 10%, 15%, 20%, 25% or at least about 30% or more as compared to the coefficient of thermal expansion of compositions lacking fillers. In certain examples, about 5 parts to about 60 parts filler per 100 parts first component may be used in the composition, more particularly about 10 parts to about 50 parts filler, or about 10 parts to about 30 parts filler, per 100 parts first component may be used in the composition, e.g., about 15 parts or about 30 parts filler per 100 parts first component may be used in the composition. The person of ordinary skill in the art, given the benefit of this disclosure, will be able to select suitable amounts of fillers for use in the compositions provided herein.

In accordance with certain examples, the compositions disclosed herein can be dissolved or suspended in an effective amount of an inert organic solvent, typically to a solute content of about 30%-60% by weight. The identity of the solvent is not critical, provided it is amenable to removal by suitable means such as evaporation. For example, aromatic hydrocarbons, such as benzene and toluene, may be used. The order of blending and dissolution is also not critical; however, in order to avoid premature curing, catalyst and hardener components generally should not be brought initially into contact with polyphenylene ether and polyepoxides at a temperature above about 60° C. Unless otherwise clear from the context, proportions of components and bromine herein do not include solvent.

In accordance with certain examples, the broad ranges of proportions and the preferred proportions of bromine and the various components in the compositions disclosed herein, based on total curable composition (excluding solvent), are:

| Component | Broad Range | Narrow Range |
|---|---|---|
| Bromine | About 5% or greater | About 5-20% |
| Polyphenylene ether | About 20-55% | About 40-50% |
| Epoxide | About 20-60% | About 45-55% |
| Compatibilizing Agent | About 0.05-6% | About 1.0-5.0% |
| Catalyst/Curing Agent | At least about 4.5 | About 15-30 |
| | mequivallents basic nitrogen | mequivallents |
| | (total) | basic nitrogen |
| | | (total) |
| Filler | About 5-60 parts per 100 | About 15-30 |
| | parts first component | parts per 100 |
| | | parts first |
| | | component |

In accordance with certain examples, one or more flame retardant synergists can be used in the compositions disclosed herein. For example, when antimony pentoxide is employed as a flame retardant synergist, it should be maintained in stable dispersion. This may be done by agitation and/or combination with a suitable dispersing agent, of which many are known in the art and exemplary dispersing agents will be readily selected by the person of ordinary skill in the art, given the benefit of this disclosure. In certain examples, the proportion of flame retardant synergist may usually be up to about 4 parts per 100 parts of the polypheneylene ether and epoxide components.

In accordance with certain examples, the compositions disclosed herein may include one or more dispersing agents. In certain examples, the dispersing agent is a polymer that is compatible with the resinous constituents of the composition but is substantially non-reactive under the conditions employed. In some examples, the dispersing agent is a polyester. More powerful dispersing agents, such as amines, may be required when fatty acid salts are present, since such salts may otherwise form insoluble complexes with flame retardant synergists.

In accordance with certain examples, a material whose presence in minor amount may improve the solvent resistance and compatibility of the curable composition, and is therefore preferred, is a aliphatic tris(dialkylphosphato)titanate. Suitable phosphatotitanates are known in the art and commercially available. Phosphatotitanates may generally be represented by formula (IV shown below). 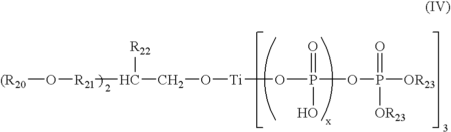
In certain examples of formula (IV), R₂₀ is C2-6 primary or secondary alkyl or alkenyl and particularly alkenyl, R₂₁ is C1-3 alkylene, R₂₂ is C1-5 primary or secondary alkyl and x is from 0 to about 3 and is particularly 0 or 1, and R₂₃ is C1-C8 alkyl. More particularly, R₂₀ is alkyl, R₂₁ is methylene, R₂₂ is ethyl, R₂₃ is octyl and x is 0. The phosphatotitanate typically may be present in the amount of about 0.1-1.0 parts by weight per 100 parts of the composition.

In accordance with certain examples, a dielectric composition comprising a first component and about 5 parts to about 60 parts of a second component per 100 parts of the first component and providing a pre-glass transition temperature coefficient of thermal expansion of no greater than about 40 to 60 ppm/° C. is provided. In certain examples, the first component comprises one or more polyphenylene ether compounds and one or more polyepoxide compounds, such as those disclosed herein, for example. In particular, the first component may comprise one or more polyphenylene ethers having two or more structural units having formula (I) above. The first component may also comprise an epoxide, such as the polyepoxides described herein, for example. In certain examples, the first component comprises about 20-55% by weight polyphenylene ether and about 20-60% by weight polyepoxide. In other examples, a compatibilizing agent, such as a transition metal salt, and/or a catalyst are optionally included in the first component of the dielectric composition. The compatibilizing agent and the catalyst may be any of those discussed herein and additional suitable compatibilizing agents and catalysts that will be readily selected by the person of ordinary skill in the art, given the benefit of this disclosure. In certain examples, about 15 parts to about 30 parts second component per 100 parts first component is used. In some examples about 15 to about 30 parts silica, e.g., fused silica, per 100 parts first component is used.

In accordance with certain examples, a dielectric composition comprising a first component and about 5 parts to about 60 parts of a second component per 100 parts of the first component and providing a post-glass transition temperature coefficient of thermal expansion of no greater than about 250 to 270 ppm/° C. is provided. In certain examples, the first component comprises one or more polyphenylene ether compounds and one or more polyepoxide compounds, such as those disclosed herein, for example. In particular, the first component may comprise one or more polyphenylene ethers having two or more structural units having formula (I) above. The first component may also comprise an epoxide, such as the polyepoxides described herein, for example. In certain examples, the first component comprises about 20-55% by weight polyphenylene ether and about 20-60% by weight polyepoxide. In other examples, a compatibilizing agent, such as a transition metal salt, and/or a catalyst are optionally included in the first component of the dielectric composition. The compatibilizing agent and the catalyst may be any of those discussed herein and additional suitable compatibilizing agents and catalysts that will be readily selected by the person of ordinary skill in the art, given the benefit of this disclosure. In certain examples, about 15 parts to about 30 parts second component per 100 parts first component is used. In some examples about 15 to about 30 parts silica, e.g., fused silica, per 100 parts first component is used.

In accordance with yet an additional aspect, a dielectric composition comprising a first component and about 5 parts to about 60 parts of a second component per 100 parts of the first component and having a glass transition temperature of at least about 140° C. is provided. In certain examples, the first component comprises one or more polyphenylene ether compounds and one or more polyepoxide compounds, such as those disclosed herein, for example. In particular, the first component may comprise one or more polyphenylene ethers having two or more structural units having formula (I) above. The first component may also comprise an epoxide, such as the polyepoxides described herein, for example. In certain examples, the first component comprises about 20-55% by weight polyphenylene ether and about 20-60% by weight polyepoxide. In other examples, a compatibilizing agent, such as a transition metal salt, and/or a catalyst are optionally included in the first component of the dielectric composition. The compatibilizing agent and the catalyst may be any of those discussed herein and additional suitable compatibilizing agents and catalysts that will be readily selected by the person of ordinary skill in the art, given the benefit of this disclosure. In certain examples, about 15 parts to about 30 parts second component per 100 parts first component is used. In some examples, about 15 to about 30 parts silica, e.g., fused silica, per 100 parts first component is used.

In accordance with yet an additional aspect, a dielectric composition comprising a first component and about 5 parts to about 60 parts of a second component per 100 parts of the first component and providing a peel strength of at least about 4 pounds per inch width as tested by IPC-TM-650 2.4.8C (dated December 1994 and entitled “Peel Strength of Metallic Clad Laminates”) and 2.4.8.2 is provided. The IPC-TM-650 2.4.8C and 2.4.8.2 tests are incorporated herein by reference for all purposes. In certain examples, the first component comprises one or more polyphenylene ether compounds and one or more polyepoxide compounds, such as those disclosed herein, for example. In particular, the first component may comprise one or more polyphenylene ethers having two or more structural units having formula (I) above. The first component may also comprise an epoxide, such as the polyepoxides described herein, for example. In certain examples, the first component comprises about 20-55% by weight polyphenylene ether and about 20-60% by weight polyepoxide. In other examples, a compatibilizing agent, such as a transition metal salt, and/or a catalyst are optionally included in the first component of the dielectric composition. The compatibilizing agent and the catalyst may be any of those discussed herein and additional suitable compatibilizing agents and catalysts that will be readily selected by the person of ordinary skill in the art, given the benefit of this disclosure. In certain examples, about 15 parts to about 30 parts second component per 100 parts first component is used. In some examples, about 15 to about 30 parts silica, e.g., fused silica, per 100 parts first component is used.

In accordance with another aspect, a dielectric composition comprising a first component and about 5 parts to about 60 parts of a second component per 100 parts of the first component and having a dielectric constant at 1 MHz (50% resin content) of about 4.0 to 5.0 or less as tested by the two fluid cell method (IPC-TM-650 2.5.5.3C dated December 1987 and entitled “Permittivity (Dielectric Constant) and Loss Tangent (Dissipation Factor) of Materials (Two Fluid Cell Method)”) is disclosed. The IPC-TM-650 2.5.5.3C test is incorporated herein by reference for all purposes. In certain examples, the first component comprises one or more polyphenylene ether compounds and one or more polyepoxide compounds, such as those disclosed herein, for example. In particular, the first component may comprise one or more polyphenylene ethers having two or more structural units having formula (I) above. The first component may also comprise an epoxide, such as the polyepoxides described herein, for example. In certain examples, the first component comprises about 20-55% by weight polyphenylene ether and about 20-60% by weight polyepoxide. In other examples, a compatibilizing agent, such as a transition metal salt, and/or a catalyst are optionally included in the first component of the dielectric composition. The compatibilizing agent and the catalyst may be any of those discussed herein and additional suitable compatibilizing agents and catalysts that will be readily selected by the person of ordinary skill in the art, given the benefit of this disclosure. In certain examples, about 15 parts to about 30 parts second component per 100 parts first component is used. In some examples, about 15 to about 30 parts, e.g., fused silica, silica per 100 parts first component is used.

In accordance with yet another aspect, a dielectric composition comprising a first component and about 5 parts to about 60 parts of a second component per 100 parts of the first component and having a dielectric dissipation factor at 1 MHz (50% resin content) of about 0.008 to 0.02 or less as tested by the two fluid cell method (IPC-TM-650 2.5.5.3C dated December 1987 and entitled “Permittivity (Dielectric Constant) and Loss Tangent (Dissipation Factor) of Materials (Two Fluid Cell Method)”) is provided. In certain examples, the first component comprises one or more polyphenylene ether compounds and one or more polyepoxide compounds, such as those disclosed herein, for example. In particular, the first component may comprise one or more polyphenylene ethers having two or more structural units having formula (I) above. The first component may also comprise an epoxide, such as the polyepoxides described herein, for example. In certain examples, the first component comprises about 20-55% by weight polyphenylene ether and about 20-60% by weight polyepoxide. In other examples, a compatibilizing agent, such as a transition metal salt, and/or a catalyst are optionally included in the first component of the dielectric composition. The compatibilizing agent and the catalyst may be any of those discussed herein and additional suitable compatibilizing agents and catalysts that will be readily selected by the person of ordinary skill in the art, given the benefit of this disclosure. In certain examples, about 15 parts to about 30 parts second component per 100 parts first component is used. In some examples, about 15 to about 30 parts silica, e.g., fused silica, per 100 parts first component is used.

In accordance with certain examples, one or more of the compositions disclosed herein may be used in one or more prepregs. Without wishing to be bound by any particular scientific theory, a prepreg comprises a substrate (e.g., woven or non-woven fibrous substrate) such as glass, quartz, polyester, polyamide, polypropylene, cellulose, nylon or acrylic fibers, low dielectric unidirectional tape, or woven cloth or non-woven fabric of interbonding fibers with a composition disposed on the substrate. Suitable low dielectric fibers include high strength fibers such as fiberglass fibers, ceramic fibers and aramid fibers, which are commercially available. In certain examples, prepreg fibers may have a consistent fiber orientation. The prepreg is impregnated with a composition, and such prepregs may be cured by application of heat and pressure. Referring now to FIG. 1, prepreg 100 comprises a generally planar substrate 110 with one or more of the compositions disclosed herein disposed on or in substrate 110. The thickness of the substrate can vary, and in certain examples, the substrate is about 1 mil to about 10 mils thick, more particularly, about 2 mils to about 9 mils thick, e.g., about 3-8, 4-7, or 5-6 mils thick. It will be within the ability of the person of ordinary skill in the art, given the benefit of this disclosure and along with fabricator's design criteria, to select suitable thicknesses for prepreg substrates.

In accordance with certain examples, a prepreg can be formed by disposing one or more of the compositions disclosed herein on or in a substrate. In certain examples, a substrate can be partially covered or masked so that only a portion of the substrate receives one or more of the compositions described herein. In other examples, substantially all areas of the substrate receive one or more of the compositions disclosed herein. An applicator, such as a brush, roller, spray nozzle, etc. can apply one or more of the compositions to the substrate. In some examples, one or more additional applications of the composition can be performed such that the substrate is substantially saturated with the composition. In certain examples, one or more areas of the substrate receive a substantially greater amount of the composition than another area. Such differential disposition of the compositions disclosed herein can provide prepregs having areas with different physical and/or electrical properties.

In accordance with certain examples, after disposal of one or more of the compositions on a substrate, the prepreg is typically stacked with other prepregs and the resulting assembly is cured to remove any solvent from the disposed composition. In certain examples, the prepreg stack is cured by placing the prepreg stack in an oven at a temperature above the vaporization temperature of the solvent. The oven temperature causes the solvent to evaporate and cures the prepreg stack. The cured prepreg stack may be used to form numerous devices, such as laminates, molded articles, printed circuit boards, etc. The person of ordinary skill in the art, given the benefit of this disclosure, will be able to use the compositions disclosed here to form prepregs.

In accordance with certain examples, the prepreg may include additional materials to alter the physical and/or electrical properties of the prepreg. For example, materials such as elastomers, thermoplastics, etc. may be added to the prepreg to alter the properties, e.g., to increase fracture resistance. The prepregs may also include fillers, whiskers, particles and the like to alter the properties of the prepreg. In some examples, the substrate of the prepreg includes, on one or both sides, cloth, a sheet of reinforcing fibers, glass, carbon fibers, aromatics, liquid crystals, fibrous mats, conductive oils, metal foils such as copper foils, etc. It will be within the ability of the person of ordinary skill in the art, given the benefit of this disclosure, to include additional materials in prepregs to impart desired physical and/or electrical properties to the prepreg.

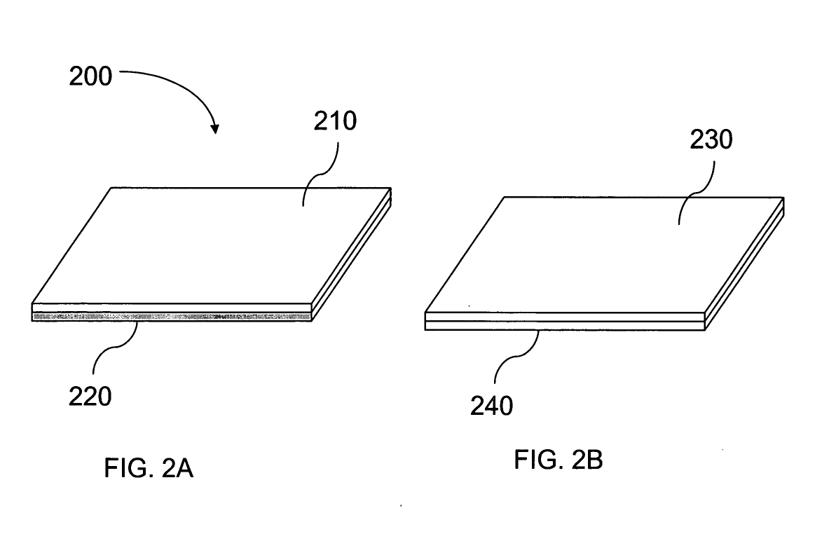

In accordance with certain examples, a laminate comprising at least two layers wherein a layer is a prepreg is disclosed. As used here, the term laminate refers to a device comprising at least two layers, wherein one of the layers is a prepreg, more particularly at least about 1 to about 10 layers of the laminate is a prepreg, e.g., about 1 to about 2 layers of the laminate are prepregs. The laminate may include one or more electrically conductive layers, e.g., non-metal or metal foil layers, disposed on one or more sides of the laminate. For example, referring to FIG. 2A, laminate 200 comprises prepreg 210 and metal foil 220. In other examples, a laminate may comprise two or more prepregs, such as prepreg 230 and prepreg 240 shown in FIG. 2B. Laminates are typically prepared by laminate-pressing, compression molding or laminate molding, as described in numerous publications and patents. For example, laminates can be produced by stacking on one another 1 to 20 pieces of prepreg, placing on one surface or both surfaces of the stacked prepreg a non-metal foil or metal foil, e.g., copper foil, aluminum foil, tin foil, etc., and subjecting the resultant structure to laminate molding. Suitable non-metal foils will be readily selected by the person of ordinary skill in the art, given the benefit of this disclosure, and exemplary non-metal foils include those containing plastics, ceramics, elastomers, carbon black, graphite, and diamond. With respect to the type of metal foil, any suitable metal foil that can be used in the application of electrically insulating materials and/or electrically conductive materials can be used. In addition, as conditions for molding, for example, those used in methods for laminated sheet and multilayer sheet for electrically insulating materials can be employed, and, for example, molding can be conducted using a multi-stage press, a multi-stage vacuum press, a continuous molding machine, or an autoclave molding machine by heating at a suitable temperature, e.g., 100 to 250° C. at a pressure of 2 to 100 kg/cm² for about 0.1 to 5 hours. Further, the prepreg can be combined with a wiring board for inner layer and subjected to laminate molding to produce a multilayer sheet. It will be within the ability of the person of ordinary skill in the art, given the benefit of this disclosure, to produce laminates using the compositions and prepregs described herein.

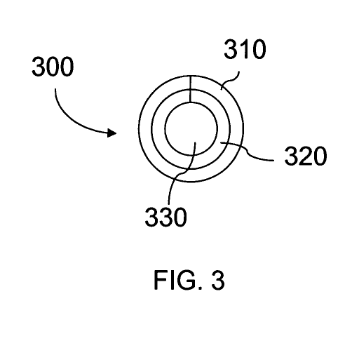

In accordance with certain examples, a molded article comprising one or more of the prepregs disclosed herein is provided. In certain examples, the molded article is produced using one or more of the compositions described herein and suitable fibers to provide a fiber reinforced plastic. In other examples, the molded article is produced from one or more prepregs and formed into a desired shape, such as a tube, by winding layers of prepregs around a device, such as a mandrel, and heating and pressing the layers. In other examples, the molded article is formed in a desired shape to provide fishing rods, golf club shafts, aircraft panels, aircraft wings, etc. In certain examples, the prepregs are cut to shape prior to curing, whereas in other examples, the prepregs are cured and then cut to a desired shape. It will be within the ability of the person of ordinary skill in the art, given the benefit of this disclosure, to produce molded articles using the compositions and prepregs disclosed herein. Referring to FIG. 3, a tubular molded article 300 comprising a prepreg, such as prepreg 310 and prepreg 320 is shown. Tubular molded article 300 is hollow and includes central void 330. Suitable molded articles using the compositions disclosed herein will be readily designed by the person of ordinary skill in the art, given the benefit of this disclosure.

In accordance with certain examples, a printed circuit board comprising one or more of the compositions disclosed herein is provided. Examples of printed circuit boards include a dielectric substrate having an electrically conductive layer on one or more surfaces. In some examples, an electrically conductive layer is formed to have a predetermined pattern. In examples using multiple electrically conductive layers, the electrically conductive layers may be connected electrically with each other. The exact nature of the dielectric substrate can vary, and exemplary materials for dielectric substrates include but are not limited to glass, woven and non-woven fabrics, and other suitable materials that can receive one or more of the compositions disclosed herein.

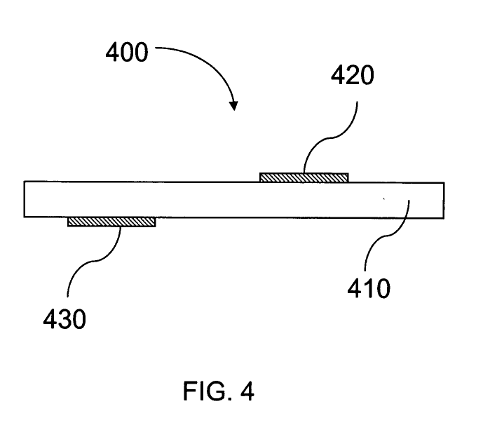

In accordance with certain examples, one or more of the compositions disclosed herein can be disposed on the dielectric substrate, and the resulting assembly can be cured to provide a printed circuit board. In some examples, the dielectric substrate comprises a single layer of material, whereas in other examples the dielectric substrate is a multi-layered structure formed, for example, from a plurality of stacked prepregs. Non-metal or metal foils can also be disposed on one or both surfaces of the dielectric substrate. In certain examples, metal foil can be disposed on one or more surfaces and etched away to provide a predetermined wiring pattern on the dielectric substrate. Referring now to FIG. 4, printed circuit board 400 includes dielectric substrate 410 and electrically conductive layers 420 and 430 that have been produced by etching away of a metal foil disposed on the surface of dielectric substrate 410. In some examples, the etched metal foil on one side of the dielectric substrate is in electrical communication with etched metal foil on an opposite side of the dielectric substrate through a channel, conduit, via or hole in the dielectric substrate. In other examples, the electrically conductive layers are not in electrical communication with each other. Suitable methods for preparing printed circuit boards including the compositions disclosed herein will be readily selected by the person of ordinary skill in the art, given the benefit of this disclosure.

Certain specific examples of compositions and their use in prepregs and laminates are discussed in more detail below. All parts and percentages are by weight unless otherwise indicated.

The following reagents were used in preparing compositions with different fillers as described in the Specific Examples below.

| Component | Chemical/Family | Supplier |
|---|---|---|
| DER-542 | Brominated diglycidyl ether | Dow Chemical |
| | of bisphenol-A | |
| Noryl PPO | Polyphenylene ether | General Electric |
| BPA | Bisphenol-A | Ashland Specialty |
| BPO | Benzoyl peroxide | Ferro Corp. |
| Brominated Epon-828 | Reaction Product of Epon- | Resolution |
| | 828 with tetrabrominated BPA | |
| EPN-1138 | Epoxidized novolac | Huntsman |
| ThermChek 705 | Zinc octoate | Ferro Corp. |
| Mistron CD | Talc Powder | Luzenac USA |
| Fuselex E2 | Fused silica powder | Tatsumori |
| Min-U-Sil 5 | Crystalline silica powder | U.S. Silica |
| Sylsia 730 | Precipitated silica powder | Fuji Silisia |
| Snow*Tex 730 | Kaolin clay powder | U.S. Silica |
| Spodumene 7.5 micro | Spodumene powder | Otavi Minerals |
| Catalyst | | |

The physical properties of the fillers that were used in the Specific Examples below are listed in the following table.

| | | | Particle | |
|---|---|---|---|---|
| | | | size | Specific |
| Filler | Product name | Chemistry | (micron) | gravity |
| Talc | Mistron CB | Magnesium silicate | 2.2 | 2.75 |
| Clay | Snow Tex 45 | Aluminum silicate | 1.5 | 2.58 |
| Spodumene | | Lithium aluminum | 5.7 | 3.2 |
| | | silica | | |
| Fused | Fuselex E-2 | Fused amorphous | 4.5 | 2.65 |
| silica | | silica | | |
| Ground | Minusil-5 | Crystalline silica | 1.7 | 2.65 |
| silica | | | | |
| Precipi- | Sylysia 730 | Precipitated | 4.0 | 2.15 |
| tated | | amorphous silica | | |
| silica | | | | |

### SPECIFIC EXAMPLE 1

32 parts of DER-542 was dissolved in 70 parts of toluene. The solution was heated up to 90° C. Then 1.3 parts of BPA was dissolved in this solution. 32 parts of Noryl PPO (intrinsic viscosity of 0.40) was added and dissolved. The solution was then stirred at 90° C. for 90 minutes to complete the equilibration of the PPO. The temperature was dropped to about 50° C. and 15 parts of brominated Epon-828 and 15 parts of EPN-1138 were added. The solution was stirred for 30 min. A selected amount of talc powder was added into the solution and stirred for at least 2 hours. The amount of talc powder varied from 0 to 15 parts/100 parts of solid composition (where the solid composition included all non-volatile components except the talc). Finally 5 parts of ThermChek 705, 1 part of Ethacure 100 and 0.5 part of catalyst (2-methyl imidazole) were added.

The mixture was then applied to glass cloth style 7628 and 2116 and treated in an oven at 160° C. for 3 minutes to form a prepreg. The prepreg was pressed to a 4-ply 2116 laminate or a 18-ply 7628 laminate at 390° C. for 4-5 hours with ½ ounce copper foil clad on both sides. The laminate properties were measured as shown in the table below. Glass transition temperature was measured using dynamical mechanical analysis (DMA) as described in IPC-TM-650 2.4.24.4 (dated November 1998), the entire disclosure of which is hereby incorporated herein by reference for all purposes. Peel strength was tested according to IPC-TM-650 2.4.8C and 2.4.8.2. Dielectric constant and dissipation factors were measured using the two fluid cell method as detailed in IPC-TM-650 2.5.5.3C.

As thermal expansion is strongly dependent on sample thickness and the amount of composition in the laminate, all measurements were normalized to a unified thickness of 115 mils for convenient comparison. To normalize the measured values, a dicy-cured 170° C. resin (FR4 material including glass cloth reinforced epoxy resin with flame retardants) was selected as a reference material.

Laminate samples with the same construction (e.g., 7628×18 for thermal expansion test, 2116×4 for DK/DF test) and with varying thicknesses were prepared using the standard material. Thermal expansion or DK/DF was tested using these standard samples and the measured properties were plotted against the sample thickness (i.e., measured property of the standard sample versus thickness of the standard sample). The curve obtained with the standard sample was used to normalize the thickness of the low expansion dielectric compositions discussed herein by assuming that the low expansion dielectric compositions discussed herein had the same trend as the standard curve. Using the standard curve, tested results of thermal expansion or DK/DF with a sample having a specific thickness were normalized to a thickness of 115 mils or 18 mils by interpolation.

| Talc amount (phr) | 0 | 5 | 10 | 15 |
|---|---|---|---|---|
| Tg by DMA (° C.) | 170 | 173 | 171 | 170 |
| Peel strength (lb/inch width) | | | | |
| [½ ounce] | | | | |
| Standard copper | 6.6-7.0 | 6.4 | 5.8 | 5.6 |
| Drum side treated copper | 5.1-6.1 | 5.7 | 5.3 | 4.9 |
| Thermal Expansion | | | | |
| (7628 × 18, 115 mil) | | | | |
| Pre-Tg CTE (ppm/° C.) | 53 | 51 | 48 | 46 |
| Post-Tg CTE (ppm/° C.) | 280 | 253 | 245 | 240 |
| Total Z-expansion (%) in | 3.35 | 3.20 | 3.10 | 2.95 |
| 50-250° C. | | | | |
| At 1 MHz, 50% resin content | | | | |
| Dielectric constant | 3.9 | 3.9 | 4.0 | 4.0 |
| Dissipation Factor | <0.008 | <0.008 | <0.008 | <0.008 |
| Time to Delaminate at 288° C. | >10 | >10 | >10 | >10 |
| (min) | | | | |
| Failure Temperature (° C.) | 320 | 320 | 320 | 320 |

By using talc filler in the compositions disclosed herein, the percent total Z-expansion was reduced by about 12% when 15 phr talc was used as compared to 0 phr talc. In addition, the pre-glass transition temperature coefficient of thermal expansion has been reduced from 53 ppm/° C. to 46 ppm/° C. (about 13% reduction), and the post glass transition temperature coefficient of thermal expansion is reduced from to 280 ppm/° C. to 240 ppm/° C. (about 14% reduction).

### SPECIFIC EXAMPLE 2

A composition was prepared according to the method described in Specific Example 1 except fused silica Fuselex E2 was used as the filler in place of the talc. The 4-ply 2116 and 18-ply 7628 laminates were prepared using the same method described in Specific Example 1. The amount of Fuselex E2 varied from 0 to 45 parts/100 parts of solid composition.

| Fuselex E2 amount (phr) | 0 | 15 | 30 | 45 |
|---|---|---|---|---|
| Tg by DMA (° C.) | 170 | 173 | 167 | 170 |
| Peel strength (lb/in) [½ oz] | | | | |
| Standard copper | 6.6-7.0 | 6.7 | 7.0 | 6.9 |
| Drum side treated copper | 5.1-6.1 | 5.5 | 5.7 | 5.6 |
| Thermal expansion | | | | |
| (7628 × 18, 115 mil) | | | | |
| Pre-Tg CTE (ppm/° C.) | 53 | 48 | 36 | 31 |
| Post-Tg CTE (ppm/° C.) | 280 | 240 | 220 | 195 |
| Total Z-expansion in 50-250° C. | 3.35 | 2.90 | 2.58 | 2.34 |
| (%) | | | | |
| At 1 MHz, 50% resin content | | | | |
| Dielectric constant | 3.9 | 4.0 | 4.0 | 4.1 |
| Dissipation factor | <0.008 | <0.008 | <0.008 | <0.008 |
| Time to delaminate at 288° C. | >10 | >10 | >10 | >10 |
| (min) | | | | |
| Failure temperature (° C.) | 320 | 320 | 319 | 320 |

By using Fuselex E2 filler in the compositions disclosed herein, the percent total Z-expansion was reduced by about 30% when 45 phr Fuselex was used as compared to no filler. In addition, the pre-glass transition temperature coefficient of thermal expansion has been reduced from 53 ppm/° C. to 31 ppm/° C. (about 42% reduction), and the post-glass transition temperature coefficient of thermal expansion has been reduced from 280 ppm/° C. to 195 ppm/° C. (about 30% reduction).

### SPECIFIC EXAMPLES 3-6

Compositions were prepared according to Specific Example 1 but using different fillers. Specific Example 3 used 20 parts Spodumene/100 parts composition, Specific Example 4 used 30 parts clay/100 parts solid composition, Specific Example 5 used 30 parts crystalline silica/100 parts solid composition and Specific Example 6 used 30 parts precipitated silica/100 parts solid composition.

| | | | 5 | 6 |
|---|---|---|---|---|
| Specific Example | 3 | 4 | Crystalline | Precipitated |
| Filler | Spodumene | Clay | silica | silica |
| Filler amount (phr) | 20 | 30 | 30 | 30 |
| Tg by DMA (° C.) | 173 | 183 | 179 | 169 |
| Peel strength (lb/in) | | | | |
| [½ oz] | | | | |
| Standard copper | 6.7 | 6.6 | 6.5 | 5.8 |
| Drum side treated | 5.7 | 5.2 | 5.1 | 4.1 |
| copper | | | | |
| Thermal expansion | | | | |
| (7628 × 18, 115 mil) | | | | |
| Pre-Tg CTE | 46 | 41 | 39 | 40 |
| (ppm/° C.) | | | | |
| Post-Tg CTE | 242 | 225 | 245 | 240 |
| (ppm/° C.) | | | | |
| Total Z-expansion in | 3.10 | 2.80 | 2.75 | 3.50 |
| 50-250° C. (%) | | | | |
| At 1 MHz, | | | | |
| 50% resin content | | | | |
| Dielectric constant | 4.3 | 4.3 | 4.2 | 4.3 |
| Dissipation factor | 0.010 | 0.011 | 0.009 | 0.009 |
| Time to delaminate at | >10 | >10 | >10 | 0 |
| 288° C. (min) | | | | |
| Failure temperature | 320 | — | — | — |
| (° C.) | | | | |

Using 30 phr clay, the total Z-expansion was reduced by about 10% (from 3.10% to 2.80%), and using crystalline silica, the total Z-expansion was reduced by about 12% (from 3.10% to 2.75%). A reduction in pre-glass transition temperature coefficient of thermal expansion was observed with all the fillers (about 13% reduction with 20 phr spodumene, about 23% reduction with 30 phr talc, about 26% reduction with 30 phr crystalline silica, and about 25% reduction with precipitated silica). A reduction post-glass transition temperature coefficients of thermal expansion was also observed with all the fillers (about 14% reduction with 20 phr spodumene, about 20% reduction with 30 phr talc, about 13% reduction with 30 phr crystalline silica, and about 14% reduction with precipitated silica). These examples show both talc and fused silica give good balance in overall performance. In particular, it was found that fused silica (Fuselex E2) provided the best overall balance in dielectric constant, thermal expansion and copper foil peel strength.

### Comparison of Fillers

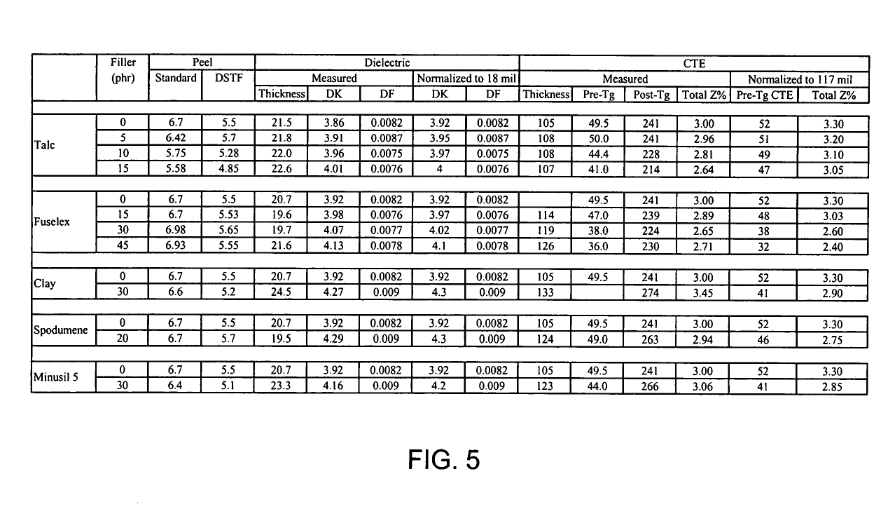

Values for the coefficient of thermal expansion (CTE) and total expansion were normalized (as discussed above) to a thickness of 115 mil for the 7628×8 laminates, while values of dielectric constant (DK) and dissipation factor (DF) were normalized to 18 mils for 2116×4 laminates. The data and normalized values are shown in FIG. 5. Thickness was measured in mils, and the CTE's are expressed in ppm/° C. 2116×4 laminates were used for peel tests and DK/DF tests. 7628×18 laminates were used for measuring CTE's.

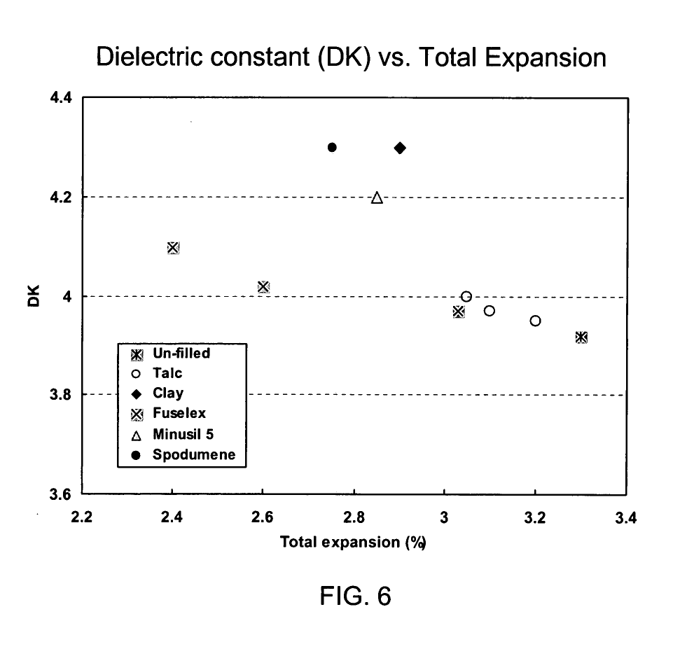

FIGS. 6-15 are graphs of the measured results listed in FIG. 5. Referring now to FIG. 6, fused silica (Fuselex E2) provided the best results when balancing dielectric constant and total expansion.

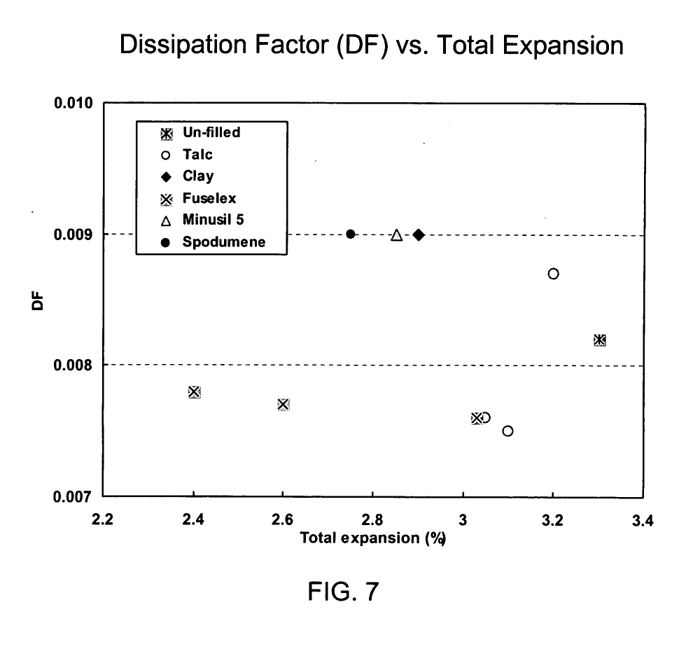

Referring to FIG. 7, fused silica (Fuselex E2) provided the best results when balancing dissipation factor and total expansion.

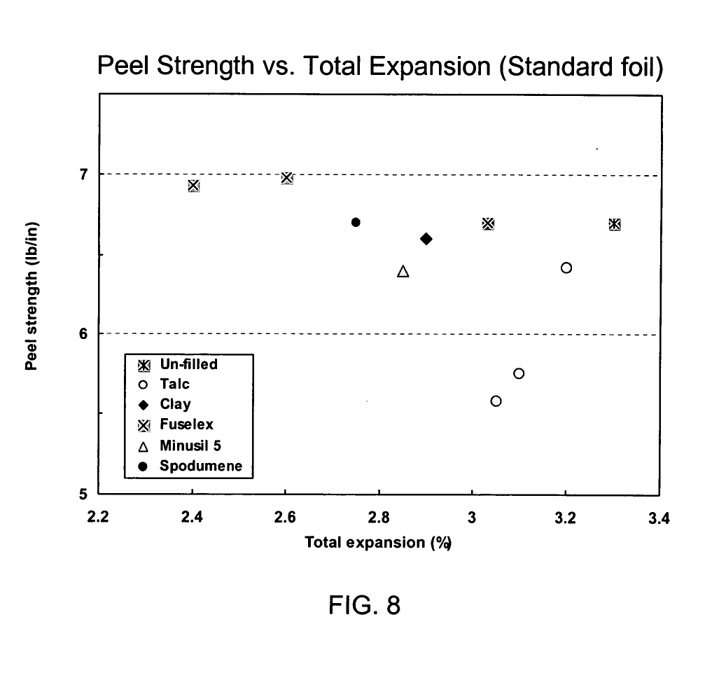

Referring to FIG. 8, yet again, fused silica (Fuselex E2) provided the best results when balancing peel strength, using standard copper foil (mat side treated foil), and total expansion.

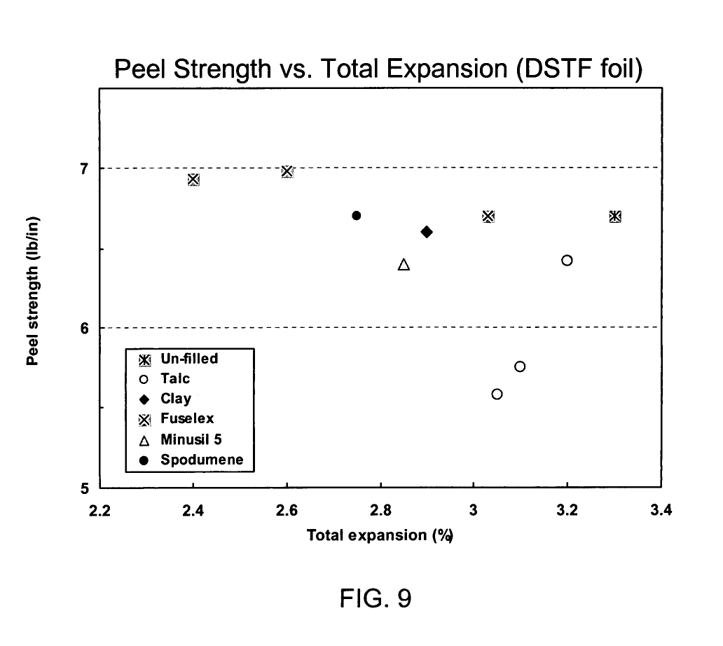

Referring to FIG. 9, fused silica (Fuselex E2) provided the best results when balancing peel strength using DSTF (drum side treated foil).

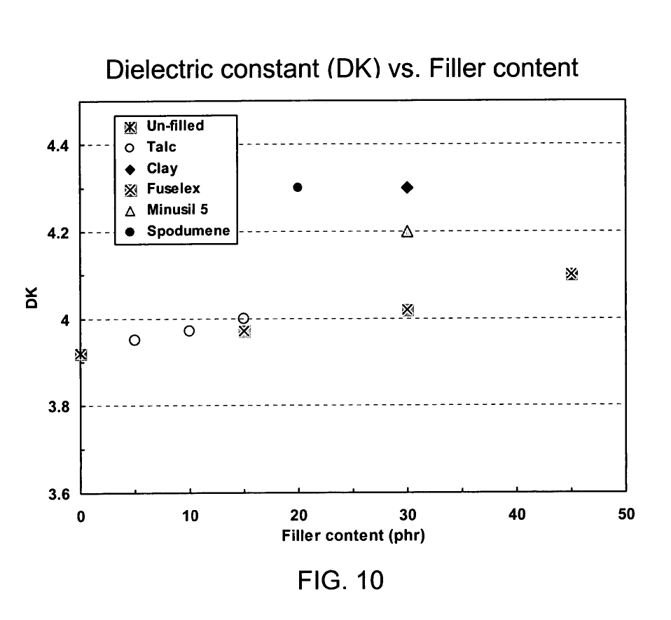

Referring to FIG. 10, the lowest DK was obtained with fused silica (Fuselex E2) for any given filler loading level (see 15, 30 and 45 phr levels).

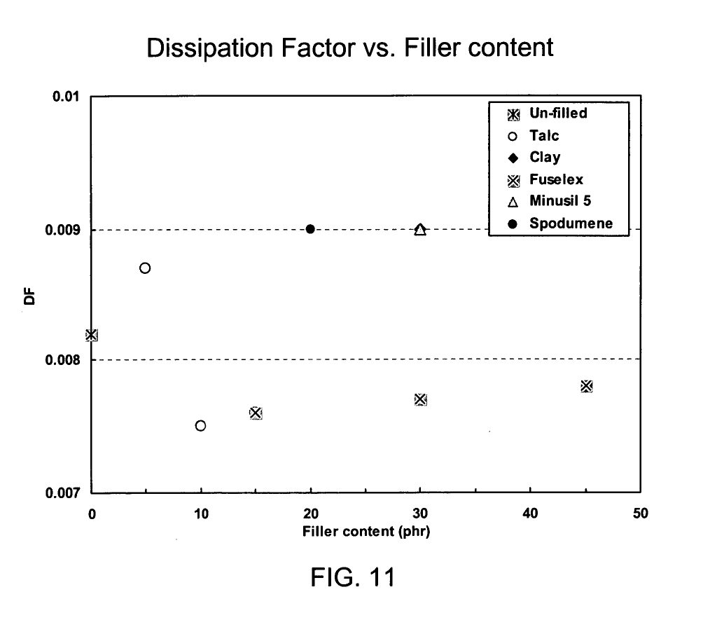

Referring to FIG. 11, at 15 to 45 phr, which loading level provides low thermal expansion, fused silica (Fuselex E2) provided the lowest DF.

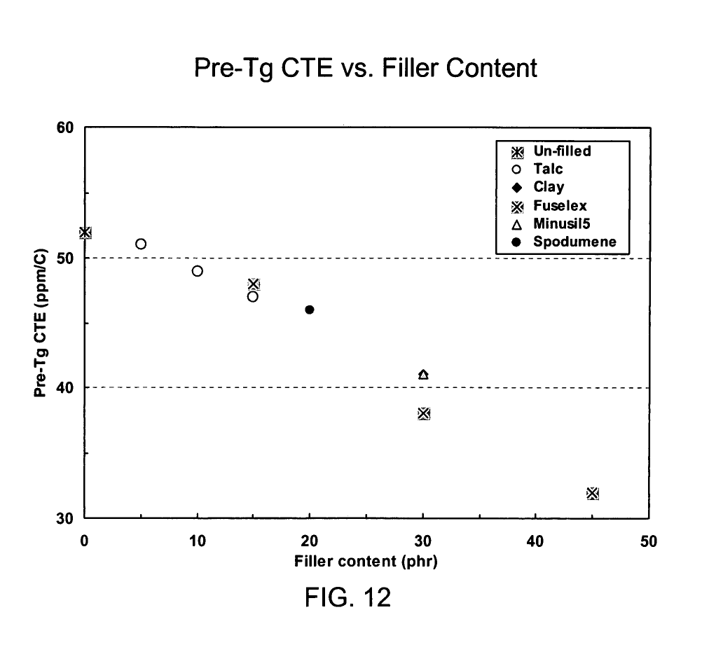

Referring to FIG. 12, all fillers provided a similar effect on pre glass transition temperature coefficients of thermal expansion, with higher loading providing lower coefficients of thermal expansion.

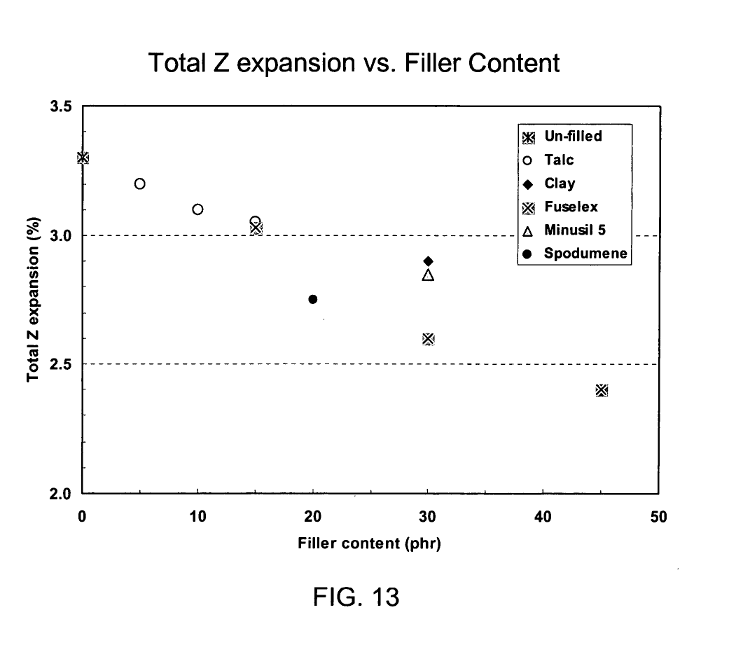

Referring to FIG. 13, all fillers provided a similar effect on total Z-expansion, with higher loading lowering the total Z-expansion.

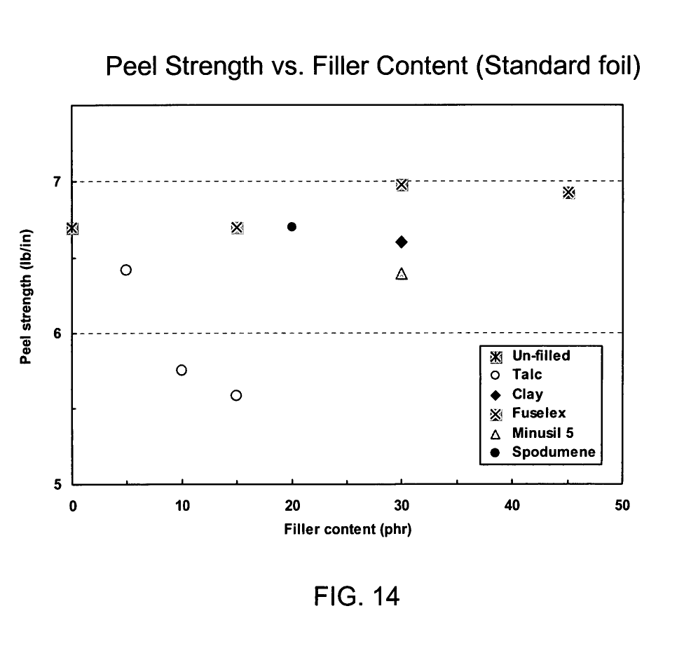

Referring to FIG. 14, fused silica (Fuselex E2) gave the highest peel strength for standard copper foil at 30 phr and 45 phr filler.

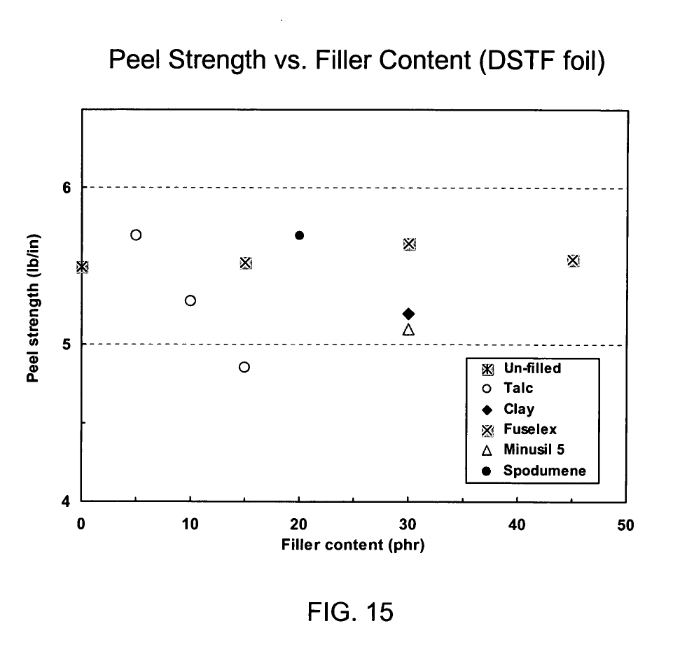

Referring to FIG. 15, fused silica (Fuselex E2) gave the highest peel strength for DSTF foil at 30 phr and 45 phr filler.

When introducing elements of the examples disclosed herein, the articles “a”, “an”, “the” and “said” are intended to mean that there are one or more of the elements. The terms “comprising”, “including” and “having” are intended to be open ended and mean that there may be additional elements other than the listed elements. It will be recognized by the person of ordinary skill in the art, given the benefit of this disclosure, that various components of the examples can be interchanged or substituted with various components in other examples. Should the meaning of the terms of any of the patents, patent applications or publications incorporated herein by reference conflict with the meaning of the terms used in this disclosure, the meaning of the terms in this disclosure are intended to be controlling.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. A dielectric composition comprising:
a first component comprising:
a polyphenylene ether,
a polyepoxide comprising about 10% to about 30% bromine as aryl substituents; and
a second component comprising about 5 to about 60 parts of a filler per 100 parts of the first component.

2. The dielectric composition of claim 1 in which the first component further comprises a compatibilizing agent and a catalyst.

3. The composition of claim 1 in which the filler is selected from the group consisting of talc, clay, mica, silica, alumina, calcium carbonate and mixtures thereof.

4. The composition of claim 1 in which the polyphenylene ether is a compound with two or more structural units having a formula of: 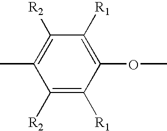
wherein each R₁ and R₂ is independently selected from the group consisting of hydrogen, primary or secondary lower alkyl, primary or secondary lower alkenyl, primary or secondary lower alkynyl, phenyl, aminoalkyl, diaminoalkyl, acyl, hydrocarbonoxy, and halohydrocarbonoxy.

5. The composition of claim 1 in which the first component comprises about 20% to about 55% by weight polyphenylene ether, based on the weight of the first component, and about 20% to about 60% by weight polyepoxide, based on the weight of the first component.

6. The composition of claim 5 in which the polyepoxide comprises a bisphenol polyglicydyl ether having an average of one aliphatic hydroxy group per molecule.

7. The composition of claim 1 in which the polyepoxide is a compound having a formula of: 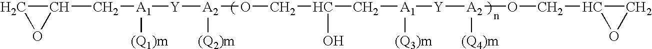
in which Q₁, Q₂, Q₃ and Q₄ each is independently selected from the group consisting of hydrogen, primary or secondary lower alkyl, aryl, in which A₁ and A₂ are independently selected from a monocyclic divalent aromatic radical, phenyl, phenoxy, unsubstituted phenylene, substituted phenylene, in which Y is a bridging radical, methyl, ethyl, or propyl, in which m is 0 to 4, and in which n has an average value between 0 and 4.

8. The composition of claim 1 in which the polyepoxide is a compound having a formula of: 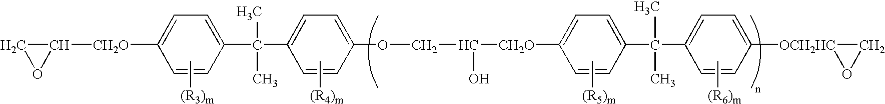
in which R₃, R₄, R₅, and R₆ each is independently selected from the group consisting of halogen, hydrogen, methyl, ethyl, ethylene, propyl, and propylene, in which n has an average value between 0 and 4, and in which m is between 1 and 4.

9. The composition of claim 1 in which the compatibilizing agent comprises a transition metal salt.

10. The composition of claim 9 in which the transition metal salt is a zinc salt selected from the group consisting of zinc octoate, di-alkyl zinc dicarboxylates, zinc mercaptides, zinc acetate, zinc oxide, zinc citrate, zinc oxylate, zinc acetylacetonate, zinc stearate, zinc naphthenate and mixtures thereof.

11. The composition of claim 9 in which the transition metal salt is a tin salt selected from the group consisting of stannous octoate, di-alkyl tin dicarboxylates, tin mercaptides, stannous acetate, stannic oxide, stannous citrate, stannous oxylate, stannous chloride, stannic chloride, tetra-phenyl tin, tetra-butyl tin, tri-n-butyl tin acetate, di-n-butyl tin dilaurate, dimethyl tin dichloride, and mixtures thereof.

12. The composition of claim 2 in which the catalyst is selected from the group consisting of imidazole, 1-methylimidazole, 1,2-dimethylimidazole, 2-methylimidazole, 2-heptadecylimidazole, 2-ethyl-4-methylimidazole, 2-undecylimidazole, 1-(2-cyanoethyl)-2-phenylimidazole, diethyltoluenediamine, tris(dimethylaminomethyl)phenol, 3-phenyl-1,1-dimethyl urea and mixtures thereof.

13. The composition of claim 1 having a glass transition temperature of at least about 140° C.

14. The composition of claim 1 having a peel strength of at least about 4 pounds per inch width as tested by IPC-TM-650 2.4.8C.

15. The composition of claim 1 comprising about 34% by weight of polyphenylene ether, and about 60% by weight polyepoxide, based on the weight of the first component.

16. The composition of claim 1 in which the composition provides a pre-glass transition temperature coefficient of thermal expansion of no greater than about 50 ppm/° C.

17. The composition of claim 1 in which the composition provides a post-glass transition temperature coefficient of thermal expansion of no greater than about 260 ppm/° C.

18. The composition of claim 1 having a dielectric constant at 1 MHz (50% weight resin) of no greater than about 4.5 as tested by IPC-TM-650 2.5.5.3C.

19. The composition of claim 1 having a dielectric dissipation factor at 1 MHz (50% weight resin) of no greater than about 0.01 as tested by IPC-TM-650 2.5.5.3C.

20. The composition of claim 1 in which the first component further comprises an initiator.

21. The composition of claim 20 in which the initiator is selected from the group consisting of benzoyl peroxide, 2,2′-azo-bis-isobutyrylnitrile, lauroyl peroxide, tert-butyl peroxy-2-ethylhexanoate and tert-amyl peroxy-2-ethylhexanoate

22. The composition of claim 1 in which the polyphenylene ether has been equilibrated with a bisphenol selected from the group consisting of diglycidyl ether bisphenol-A type epoxides, bisphenol-F type epoxides, epoxidized novolac type epoxides, phosphorated epoxides, and cycloaliphatic epoxides.

22. The composition of claim 1 in which the filler is silica.

23. The composition of claim 22 in which the silica is fused silica.

24. The composition of claim 23 in which the fused silica is present at about 15-30 parts fused silica per 100 parts of the first component.

25. The composition of claim 23 in which the composition provides a pre-glass transition temperature coefficient of thermal expansion of no greater than about 50 ppm/° C.

26. The composition of claim 23 in which the composition provides a post-glass transition temperature coefficient of thermal expansion of no greater than about 260 ppm/° C.

27. The composition of claim 23 having a dielectric constant at 1 MHz (50% weight resin) of no greater than about 4.5 as tested by IPC-TM-650 2.5.5.3C.

28. The composition of claim 23 having a dielectric dissipation factor at 1 MHz (50% weight resin) of no greater than about 0.01 as tested by IPC-TM-650 2.5.5.3C.

29. A dielectric composition comprising:
a first component comprising a polyphenylene ether and a polyepoxide; and
a second component comprising about 5 parts to about 60 parts of a filler per 100 parts of the first component,
the dielectric composition providing a pre-glass transition temperature coefficient of thermal expansion of no greater than about 50 ppm/° C.

30. The dielectric composition of claim 29, in which the first component further comprises a compatibilizing agent and a catalyst.

31. The dielectric composition of claim 29, in which the filler is selected from the group consisting of talc, clay, mica, silica, alumina, calcium carbonate and mixtures thereof.

32. The dielectric composition of claim 29, in which the filler is fused silica.

33. The composition of claim 32 in which the fused silica is present at about 15-30 parts fused silica per 100 parts of the first component.

34. The dielectric composition of claim 32 in which the composition provides a post-glass transition temperature coefficient of thermal expansion of no greater than about 260 ppm/° C.

35. The dielectric composition of claim 32 having a dielectric constant at 1 MHz (50% weight resin) of no greater than about 4.5 as tested by IPC-TM-650 2.5.5.3C.

36. The dielectric composition of claim 32 having a dielectric dissipation factor at 1 MHz (50% weight resin) of no greater than about 0.01 as tested by IPC-TM-650 2.5.5.3C.

37. A dielectric composition comprising:
a first component comprising a polyphenylene ether and a polyepoxide; and a second component comprising about 5 parts to about 60 parts of filler per 100 parts of the first component,
the dielectric composition providing a post-glass transition temperature coefficient of thermal expansion of no greater than about 260 ppm/° C.

38. The dielectric composition of claim 37, in which the first component further comprises a compatibilizing agent and a catalyst.

39. The dielectric composition of claim 37, in which the filler is selected from the group consisting of talc, clay, mica, silica, alumina, calcium carbonate and mixtures thereof.

40. The dielectric composition of claim 37, in which the filler is fused silica.

41. The dielectric composition of claim 40, in which the fused silica is present at about 15-30 parts fused silica per 100 parts of the first component.

42. The dielectric composition of claim 40 having a dielectric constant at 1 MHz (50% weight resin) of no greater than about 4.5 as tested by IPC-TM-650 2.5.5.3C.

43. The dielectric composition of claim 40 having a dielectric dissipation factor at 1 MHz (50% weight resin) of no greater than about 0.01 as tested by IPC-TM-650 2.5.5.3C.

44. A dielectric composition comprising:
a first component comprising a polyphenylene ether and a polyepoxide; and
a second component comprising about 5 parts to about 60 parts of filler per 100 parts of the first component,
the dielectric composition having a glass transition temperature of at least about 140° C.

45. The dielectric composition of claim 44, in which the first component further comprises a compatibilizing agent and a catalyst.

46. The dielectric composition of claim 44, in which the filler is selected from the group consisting of talc, clay, mica, silica, alumina, calcium carbonate and mixtures thereof.

47. The dielectric composition of claim 44, in which the filler is fused silica.

48. The dielectric composition of claim 45, in which the fused silica is present at about 15-30 parts fused silica per 100 parts of the first component.

49. A dielectric composition comprising:
a first component comprising a polyphenylene ether and a polyepoxide; and
a second component comprising about 5 parts to about 60 parts of filler per 100 parts of the first component,
the dielectric composition providing a peel strength of at least about 4 pounds per inch width as tested by IPC-TM-650 2.4.8C.

50. The dielectric composition of claim 49, in which the first component further comprises a compatibilizing agent and a catalyst.

51. The dielectric composition of claim 49, in which the filler is selected from the group consisting of talc, clay, mica, silica, alumina, calcium carbonate and mixtures thereof.

52. The dielectric composition of claim 49, in which the filler is fused silica.

53. The dielectric composition of claim 52, in which the fused silica is present at about 15-30 parts fused silica per 100 parts of the first component.

54. A dielectric composition comprising:
a first component comprising a polyphenylene ether and a polyepoxide; and
a second component comprising about 5 parts to about 60 parts of filler per 100 parts of the first component,
the dielectric composition having a dielectric constant at 1 MHz (50% resin content) of about 4.5 or less as tested by IPC-TM-650 2.5.5.3C.

55. The dielectric composition of claim 54, in which the first component further comprises a compatibilizing agent and a catalyst.

56. The dielectric composition of claim 54, in which the filler is selected from the group consisting of talc, clay, mica, silica, alumina, calcium carbonate and mixtures thereof.

57. The dielectric composition of claim 54, in which the filler is fused silica.

58. The dielectric composition of claim 57, in which the fused silica is present at about 15-30 parts fused silica per 100 parts of the first component.

59. A dielectric composition comprising:
a first component comprising a polyphenylene ether and a polyepoxide; and
a second component comprising about 5 parts to about 60 parts of filler per 100 parts of the first component,
the dielectric composition having a dielectric dissipation factor at 1 MHz (50% resin content) of about 0.01 or less as tested by IPC-TM-650 2.5.5.3C.

60. The dielectric composition of claim 59, in which the first component further comprises a compatibilizing agent and a catalyst.

61. The dielectric composition of claim 59, in which the filler is selected from the group consisting of talc, clay, mica, silica, alumina, calcium carbonate and mixtures thereof.

62. The dielectric composition of claim 59, in which the filler is fused silica.

63. The dielectric composition of claim 62, in which the fused silica is present at about 15-30 parts fused silica per 100 parts of the first component.

64. A prepreg comprising a substrate impregnated with the composition of claim 1.

65. The prepreg of claim 64 wherein the substrate comprises cloth, a sheet of reinforcing fibers, glass, carbon fiber, aromatics, liquid crystals, fibrous mats, and conductive oils.

66. A laminate comprising a first substrate stacked on a second substrate, wherein at least one of the first and second substrates comprises the composition of claim 1.

67. The laminate of claim 66 further comprising an electrically-conductive layer disposed on a surface of the laminate.

68. A laminate comprising at least two of the prepregs of claim 64.

69. The laminate of claim 68 further comprising a electrically-conductive layer disposed on a surface of the laminate.

70. A molded article comprising a plurality of layers wherein at least one of the plurality of layers is impregnated with the composition of claim 1.

71. A molded article comprising a plurality of layers impregnated wherein at least one of the layers is the prepreg of claim 64.

72. A printed circuit board comprising a dielectric substrate having an electrically conductive layer on at least a surface, the electrically conductive layer being formed to have a predetermined pattern, wherein the dielectric substrate comprises a glass cloth or a glass non-woven fabric impregnated with the composition of claim 1.

73. A method of making a prepreg comprising disposing a dielectric composition on a substrate, the dielectric composition comprising:
a first component comprising a polyphenylene ether, a polyepoxide, a compatibilizing agent and a catalyst; and
a second component comprising about 5 parts to about 60 parts of a filler per 100 parts of the first component.

74. A method of making a printed circuit board comprising:
disposing a dielectric composition on a substrate comprising an electrically-conductive layer, the dielectric composition comprising:
a first component comprising a polyphenylene ether, a polyepoxide, a compatibilizing agent, and a catalyst
a second component comprising about 5 parts to about 60 parts of a filler per 100 parts of the first component; and
curing the substrate with the disposed dielectric composition.

75. A method of facilitating assembly of a prepreg, the method comprising providing the composition of claim 1.

76. A method of facilitating assembly of a printed circuit board, the method comprising providing the composition of claim 1.
